(19) United States
(12) Patent Application Publication
(10) Pub. No.: US 2014/0249957 A1
(43) Pub. Date: Sep. 4, 2014

(54) MOBILE APPLICATION FOR IN-STORE USE

(71) Applicant: BAZAARVOICE, INC., Austin, TX (US)

(72) Inventors: Anupam Saha, Austin, TX (US); Joseph I. McCann, Austin, TX (US); Amalia Litsa, Austin, TX (US); Alexander Medearis, Austin, TX (US)

(73) Assignee: BAZAARVOICE, INC., Austin, TX (US)

(21) Appl. No.: 13/831,540

(22) Filed: Mar. 14, 2013

Related U.S. Application Data
(60) Provisional application No. 61/771,921, filed on Mar. 3, 2013.

(51) Int. Cl. G06Q 30/06

(52) U.S. Cl. CPC G06Q 30/0613
USPC 705/26.41

(57) ABSTRACT

According to some embodiments of this disclosure, a software application running on a mobile device (e.g., a tablet or smartphone device) is provided which may be used by a sales associate in a physical store of an entity to assist a consumer in shopping for products or services. For example, the software application may be used by the associate to retrieve and display user generated content (UGC) items related to the products or services to assist the consumer in shopping. The software application may also store a browsing history for the user, and the sales associate may then transmit the browsing history to the consumer (e.g., via email or other electronic message).

### CROSS-REFERENCE TO RELATED APPLICATIONS

This application claims priority to U.S. Provisional Application No. 61/771,921, filed Mar. 3, 2013, which is incorporated by reference herein.

### BACKGROUND

This disclosure relates to sales of products and/or services, and more particularly to the use of an application on a mobile device for sales in an in-store (e.g., “brick-and-mortar”) environment.

Consumers who are interested in products and/or services are known sometimes to engage in what is known as “showrooming.” Showrooming is the practice of examining and selecting items in an in-store environment, but then purchasing the desired items elsewhere (e.g., via the Internet). This presents the problem of lost sales for the brick-and-mortar establishment.

Showrooming may be attractive to consumers for a variety of reasons. After evaluating products and/or services in-person, consumers may be able to realize lower prices by purchasing online, typically due to the lower overhead costs of establishments that need not maintain a physical storefront presence. Further, the Internet provides access to a variety of product reviews and comparisons that may help consumers make purchasing decisions.

### SUMMARY

According to one embodiment of this disclosure, a method is provided including a sales associate, in a physical store of an entity, using a software application running on a mobile device to assist a consumer in shopping for products or services offered via the physical store. According to this embodiment, the software application is executable to retrieve user-generated content (UGC) items regarding the products or services, and to display at least a portion of the retrieved UGC items on the mobile device, the software application is executable to cause storage of a browsing history indicative of one or more products and services for which the consumer viewed information via the software application, and the software application is executable to initiate an electronic message to the consumer that is usable to view the browsing history.

According to another embodiment of this disclosure, a computer-readable medium is provided that has instructions coded thereon which, when executed by a computing device, cause the computing device to carry out operations including retrieving user-generated content (UGC) items regarding products or services offered for purchase by the entity via the physical store, displaying at least a portion of the retrieved UGC items to a consumer, causing storage of a browsing history indicative of one or more products and services for which the consumer viewed information via the mobile device at the physical store, and initiating generation of an electronic message to the consumer that is usable to view the browsing history and to effectuate an online purchase of one or more products or services included in the browsing history.

According to a third embodiment of this disclosure, a mobile device is provided that includes at least one processor and a storage medium having instructions coded thereon which, when executed by the mobile device, cause the mobile device to carry out operations including storing, via a software application executing on the mobile device, a browsing record of products or services viewed by a consumer using the software application at a physical store of an entity, initiating sending an electronic message to the consumer, wherein the electronic message is usable to view the browsing record, and receiving from the consumer, at a computer system associated with the entity, a request to purchase one or more of the products or services indicated in the browsing record, wherein the request is received via a link included in the browsing record, and storing an indication that the request to purchase is attributable to the physical store.

### BRIEF DESCRIPTION OF THE DRAWINGS

FIG. 1 is a diagram illustrating the topology of one embodiment of a system in which embodiments of the present disclosure may be implemented.

FIGS. 2-20 are screenshots depicting aspects of various embodiments of the present disclosure.

FIG. 21 is a diagram illustrating an exemplary computer-readable medium that may be used for encoding various aspects of the present disclosure.

FIG. 22 is a diagram illustrating an exemplary computer system that may embody various aspects of the present disclosure.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The following paragraphs provide definitions and/or context for terms found in this disclosure (including the appended claims):

“Comprising.” This term is open-ended. As used herein, this term does not foreclose additional structure or steps. Consider a claim that recites: “a system comprising a processor and a memory . . . .” Such a claim does not foreclose the system from including additional components such as interface circuitry, a graphics processing unit (GPU), etc.

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation(s), etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

“First,” “Second,” etc. As used herein, these terms are used as labels for nouns that they precede unless otherwise noted, and do not imply any type of ordering (e.g., spatial, temporal, logical, etc.). For example, a “first” computing system and a “second” computing system can be used to refer to any two computing systems. In other words, “first” and “second” are descriptors.

“Based On” or “Based Upon.” As used herein, these terms are used to describe one or more factors that affect a determination. These terms do not foreclose additional factors that may affect a determination. That is, a determination may be solely based on the factor(s) stated or may be based on one or more factors in addition to the factor(s) stated. Consider the phrase “determining A based on B.” While B may be a factor that affects the determination of A, such a phrase does not foreclose the determination of A from also being based on C. In other instances, however, A may be determined based solely on B.

“Provider.” As used herein, this term includes its ordinary meaning and may refer, in various embodiments, to a manufacturer, offeror or provider of services, restaurant, reseller, retailer, wholesaler, and/or distributor.

“User generated content” (UGC). As used herein, this term refers to text, audio, video, or another information carrying medium that is generated by a user who may be a consumer of something (e.g., of goods, a product, a website, a service), a purchaser of that something, or may otherwise have an interest in that something. User generated content includes, in various embodiments, user reviews, user stories, ratings, comments, problems, issues, questions, answers, opinions, or other types of content.

“Electronic message.” As used herein, this term refers to any communication that can be conveyed electronically. Non-limiting examples include email, text message, SMS, MMS, instant message, and fax.

“Coupon.” As used herein, this term refers broadly to any financial incentive for purchasing an item. It should be interpreted to include a price discount on a particular item, a price discount on items from a particular manufacturer, bundling incentives, and other financial incentives for purchasing an item. Coupons may be implemented in any suitable way, including physical paper, electronic messages, scannable barcodes, and various other possibilities.

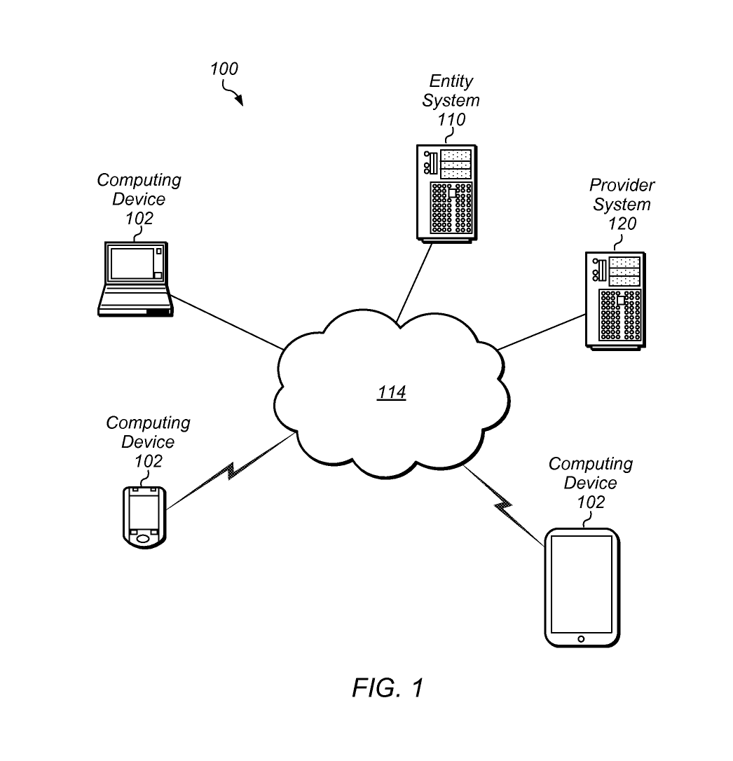

Turning now to FIG. 1, one embodiment is shown illustrating an exemplary system overview 100 that may be used for implementing various aspects of the present disclosure. In this figure, one or more computing devices 102 may be in communication with one or more entity systems 110 and/or one or more provider systems 120 via a network 114. Network 114 may be the Internet in some embodiments, and may include one or more other networks (not depicted), wired or wireless communication links, etc.

Computing devices 102 may be mobile devices (e.g., tablets, smartphones, palmtops, or other mobile devices), laptops, desktops, or other types of computing systems. In various embodiments, user computing device 102 may correspond to one or more aspects of computer system 2200 (described below relative to FIG. 22). Likewise, system 120 may by any type of computing system, and in various embodiments may correspond to one or more aspects of computer system 2200. In some embodiments, computing device 102 is associated with a first sales associate who may use computing device 102 to provide, view, or otherwise interact with UGC. For example, the sales associate may use computing device 102 to display product information, product comparisons, product reviews, and the like to a consumer interested in buying a product. One of ordinary skill will understand that the term “product” as used in this disclosure can be understood as a shorthand that should be interpreted to include services as well, even where “services” are not explicitly mentioned.

Entity system 110 may be any computer system associated with an entity that sells goods and/or services in various embodiments. For example, entity system 110 may be owned or operated by a particular retail store, a chain of retail stores, a chain of service providers, etc. In other embodiments, it may be owned or operated by another party (e.g., a third party having a relationship with the entity).

Provider system 120 may be any computer system associated with a provider of goods and/or services in various embodiments. Thus, provider system 120 is owned or operated by a provider in some embodiments, while in other embodiments, it may be owned or operated by another party (e.g., a third party having a relationship with the provider).

In various embodiments, a sales associate in a physical store of an entity may use a software application running on a mobile device (e.g., a tablet or smartphone device) to assist a consumer in shopping for products or services. In some embodiments, this disclosure may also be used in the context of a showroom, a convention, and/or other suitable venues in which products or services may be purchased and/or browsed, rather than (or in addition to) in a traditional retail store.

For example, the software application may be used by the associate to retrieve and display UGC items related to the products or services (e.g. reviews, ratings, comments, questions, etc.). The software application may also store a “browsing history” (e.g., a record indicating the particular products or services that a consumer viewed in the physical store, a record alternately or additionally indicating items that the consumer may have compared to the particular products or services) for the user, and the sales associate may then transmit the browsing history to the consumer (e.g., via email or other electronic message). In some embodiments, rather than transmitting the browsing history itself, the sales associate may transmit a link that allows the consumer to access the browsing history.

If the consumer receives such an electronic message with his browsing history, he may in some embodiments use that message to complete the purchase of the item. In this way, the consumer may receive relevant information related to the products he has already viewed in-store and an option to purchase the products from the same entity. This may simplify the process of consummating a purchase from that entity, relative to the prospect of the consumer performing his own additional online research at home (e.g., unrelated to the in-store browsing), and then buying a product from some other online retailer. This aspect of the present disclosure may mitigate the showrooming problem mentioned above, in which a consumer handles products in-store, but then performs research and makes purchases elsewhere. According to this aspect, a sales associate may help a consumer conduct online research in-store, and the results of such research may be provided to the consumer at home.

In various aspects, the electronic message to the consumer may include code or links that are configured to attribute any eventual sale resulting from the electronic message to the particular sales associate who assisted the consumer in-store. For example, the browsing history itself may include an indication of the sales associate to be credited, such that any sale originating from that browsing history is tied to the associate. In other embodiments, the electronic message may include links that have embedded therein an indication of the sales associate. In yet other embodiments, the electronic message may include links that take the consumer to web pages that use cookies to provide an indication that the sales associate should be credited. There are of course various ways of indicating that a sale should be attributed to the sales associate, and this aspect may be particularly useful in commission-based sales environments.

According to another aspect, the electronic message to the consumer may further include a machine-readable image, such as a barcode. In some embodiments, a two-dimensional barcode (e.g., a QR code or a QR-type code) may be used. By supplying this barcode upon a subsequent visit to the store, the consumer may gain access to his previous search and browsing history instead of having to try to recreate it. For example, the consumer may display the barcode on a smartphone, and a sales associate may use a mobile device to scan the screen of the consumer's smartphone. This aspect may be particularly useful when, during the subsequent visit, the consumer is being helped by a different sales associate who is not familiar with the details of the previous visit. This aspect may further be advantageously employed across different physical stores of a particular entity. According to some embodiments, a reference number may be used in place of a barcode for this purpose, but the use of a barcode or other computer-scannable pattern may provide quicker access to a consumer's browsing history.

A software application according to this disclosure may also in some embodiments be used to store notes entered by the sales associate or the consumer. For example, a sales associate might annotate a particular product with a comment that the consumer was interested, but that the store did not have the consumer's preferred color in stock. Another example of such a note may include information about what product a consumer ultimately chooses (particularly when, for example, two or more products are under consideration). Such messages may be helpful to future sales associates during a consumer's subsequent visits, as well as for purposes of collecting data about consumer preferences in the aggregate.

A mobile application according to this disclosure may also in some embodiments be used for internal messaging for various purposes. For example, a particular sales associate may send a note to other associates (e.g., in the same store location and/or in other affiliated store locations) that may be capable of providing an immediate response to a consumer's question that the particular associate cannot answer. In other embodiments, the application may also be used to store information about a product that may be of general relevance to other consumers in the future who are interested in the product.

For example, if a particular question frequently arises concerning a product, and a sales associate does research to answer that question, it may be advantageous to annotate that product's information with the answer. As another example, if it is known that a particular product has an issue (e.g., a washing machine has excessive vibration issues), that product might be annotated with an appropriate suggestion to other sales associates (e.g., to suggest an anti-vibration stand to purchasers of the washing machine). Such annotations may in various embodiments be sharable within a particular store location, across stores of an entity within a geographical region, across all stores of an entity, with other entities, and/or with the manufacturer/provider of the product. For example, it may be advantageous to be able to ask a question to a provider of a product (e.g., a retailer may forward a question to a manufacturer), and then optionally annotate the product with the received response.

According to another aspect of this disclosure, coupons may be provided to the consumer. Such coupons may in some embodiments be provided according to rules established by providers (e.g., manufacturers, brands). Rules may also in other embodiments by established by various other parties; for example, a retail store, a chain of retail stores, or a provider of the software application itself could all establish rules for couponing purposes. For example, consider a situation in which a consumer is comparing products from two providers, and historical data suggests that under similar circumstances, consumers usually select the first provider. In this case, a rule according to the second provider might offer the consumer a discount on the second provider's product. The amount of the coupon may be a fixed amount, or it may be adjusted by the rule in order to bring the providers into (or beyond) parity. Such a rule may be based on a provider generally, on the particular product in question, and/or on any other relevant information or metrics. In various embodiments, such coupons may be dynamically provided to the consumer. What is meant by “dynamically” in this context is that the coupons are based at least in part on the interaction with an in-store application (e.g., a consumer's comparing products of two particular providers) according to this disclosure.

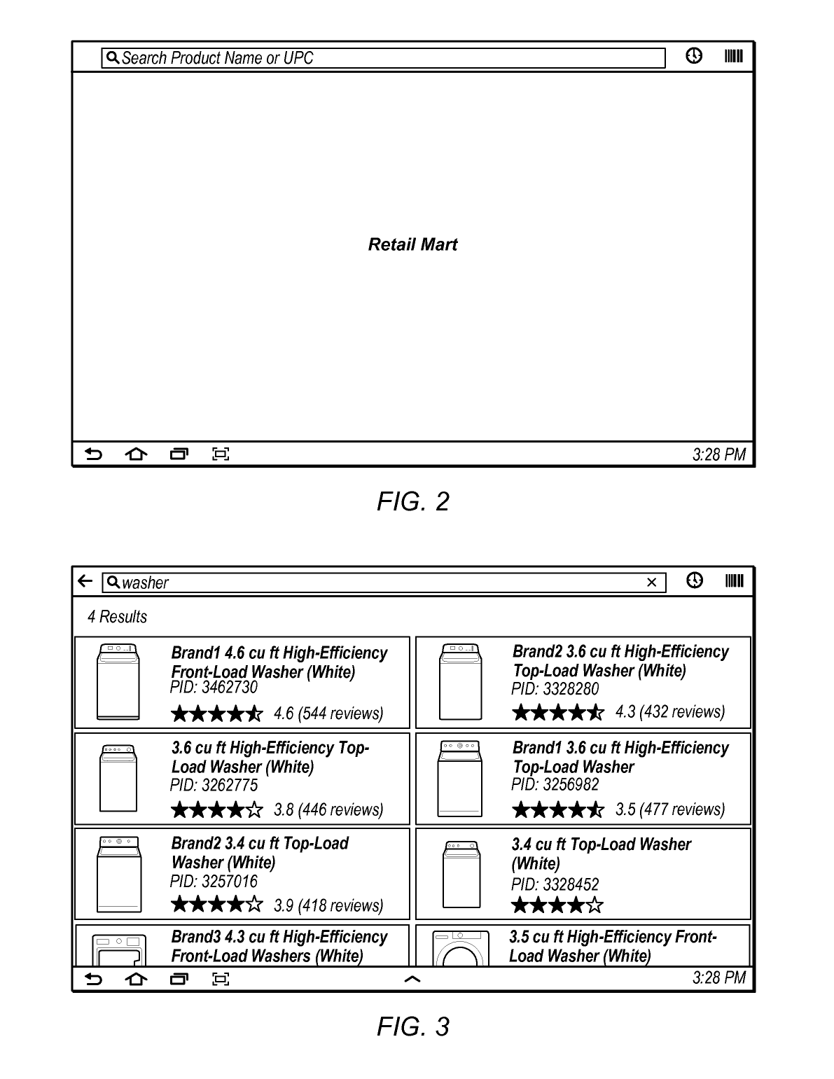

Turning now to FIGS. 2-20, a variety of exemplary screenshots are provided that illustrate some aspects of some embodiments of this disclosure. These screenshots depict various applications that may be run on computing devices 102. For example, in some embodiments, sales associates at an entity may have computing devices such as computing devices 102 (e.g., tablets or smartphones) with access to the depicted applications. Such computing devices may in some embodiments be dedicated machines capable of running only the system of this disclosure, or they may be general-purposes machines with the present disclosure provided (for example) via a software application. The sales associates may thus be provided with access to various information items that may be relevant to consumers.

One of ordinary skill in the art will understand that the various features and elements shown in these screenshots are exemplary only. Any particular embodiment according to the present disclosure may include some, all, or none of the features shown in the following screenshots.

FIG. 2 shows a screenshot of a homepage of an application in accordance with this disclosure. As shown, the application in this embodiment is branded specifically to a particular provider (e.g., Retail Mart in this embodiment). In some embodiments, thus, the application may be a custom application specific to a particular provider (e.g., a retail chain). In these embodiments, the application may typically provide information about the products and/or services offered by that particular provider, but not about products and/or services that are not offered by that particular provider. In other embodiments, the application may be a general-purpose application that is not tied to any particular provider.

FIG. 3 shows a screenshot of another aspect of an application in accordance with this disclosure. In this aspect, a user (e.g., a sales associate) has performed a search for the term “washer,” and the application has returned a list of 99 results. A portion of the search results may be visible to the user, along with some summary information (e.g., title, product ID, star rating, number of user reviews, etc.). In some embodiments, the search results may be ranked by relevance and/or by popularity. Some embodiments of ranking algorithms may rely only on star rating, while others may additionally or alternately be based on the number of reviews (e.g., a product with 4.5 stars based on 1,000 reviews may rank higher than a product with 5.0 stars based on only 1 review). In some embodiments, the list of results may be loaded optimistically, or pre-fetched. For example, the application may load enough data to display one screen of results and display that screen, and then in the background may continue to load results that would appear farther down the list. In this way, if the user scrolls toward results that are lower in the result list, they may already be available and thus accessed quickly.

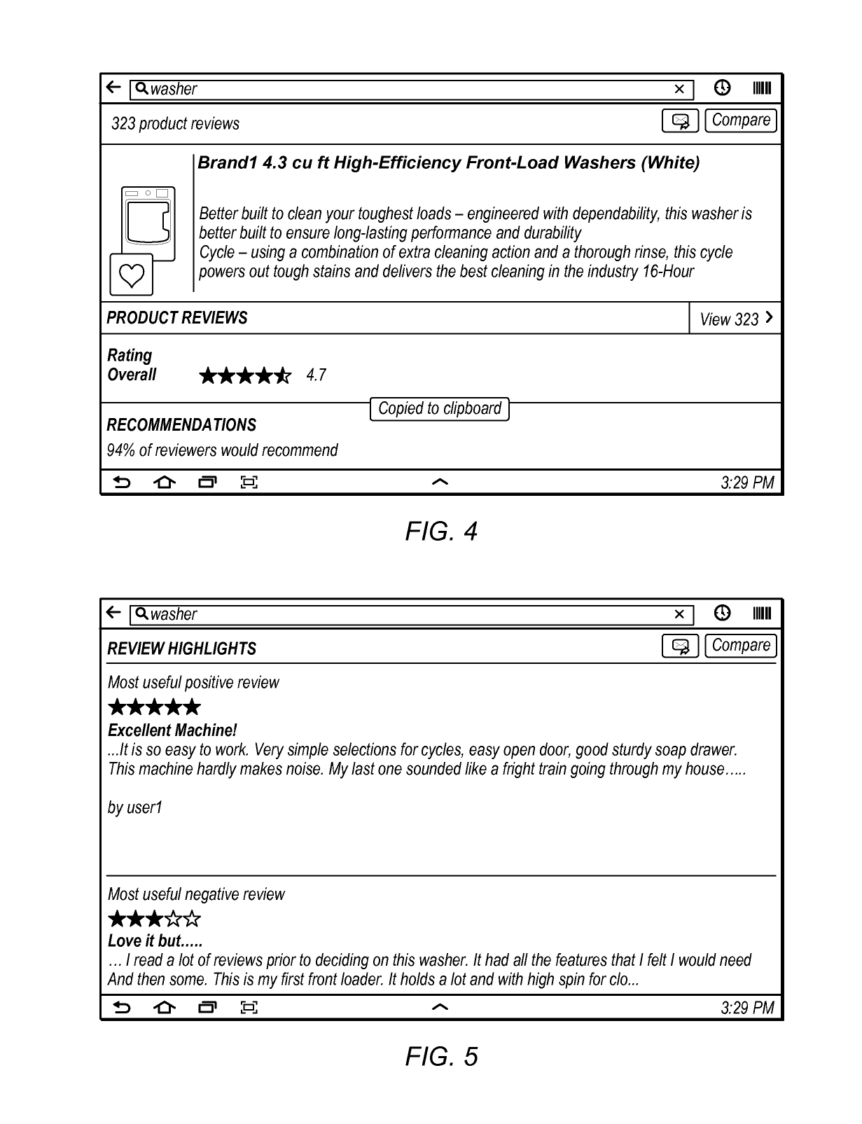

FIG. 4 shows a screenshot of a summary page for a particular product selected by a user. Such a summary page may provide a brief description of a product, as well a summary of its UGC information, such as ratings and recommendations information. The summary page shown in FIG. 4 also provides access to detailed reviews, as well as an option to compare the product with other products.

FIG. 5 shows a screenshot of a review highlights page for a particular product selected by a user. Such a review highlights page may provide quick access to highly rated reviews (e.g., both positive and negative reviews). This capability demonstrates another aspect of the present disclosure, which is that UGC itself may be graded by users. For example, a well-reasoned, articulate explanation of a product's flaws may be considered highly valuable UGC, and users may tend to rate it highly. This may increase the visibility of that particular piece of negative UGC in the context of an in-store application according to the present disclosure.

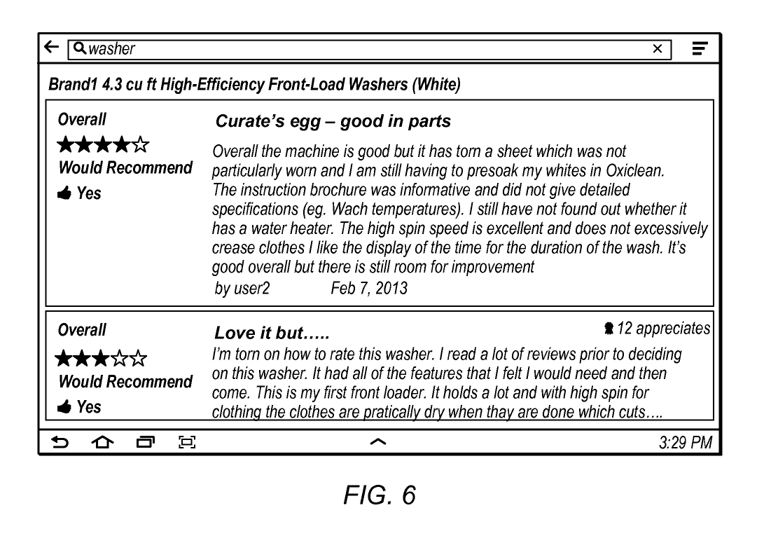

FIG. 6 shows a screenshot of a reviews page for a particular product selected by a user. In contrast to a review highlights page, as in FIG. 5, a reviews page may provide access to all available reviews and/or other UGC associated with the product. Such UGC may be sorted according to various data, such as rank (e.g., the number of people who “appreciate” the UGC), star rating, date, etc.

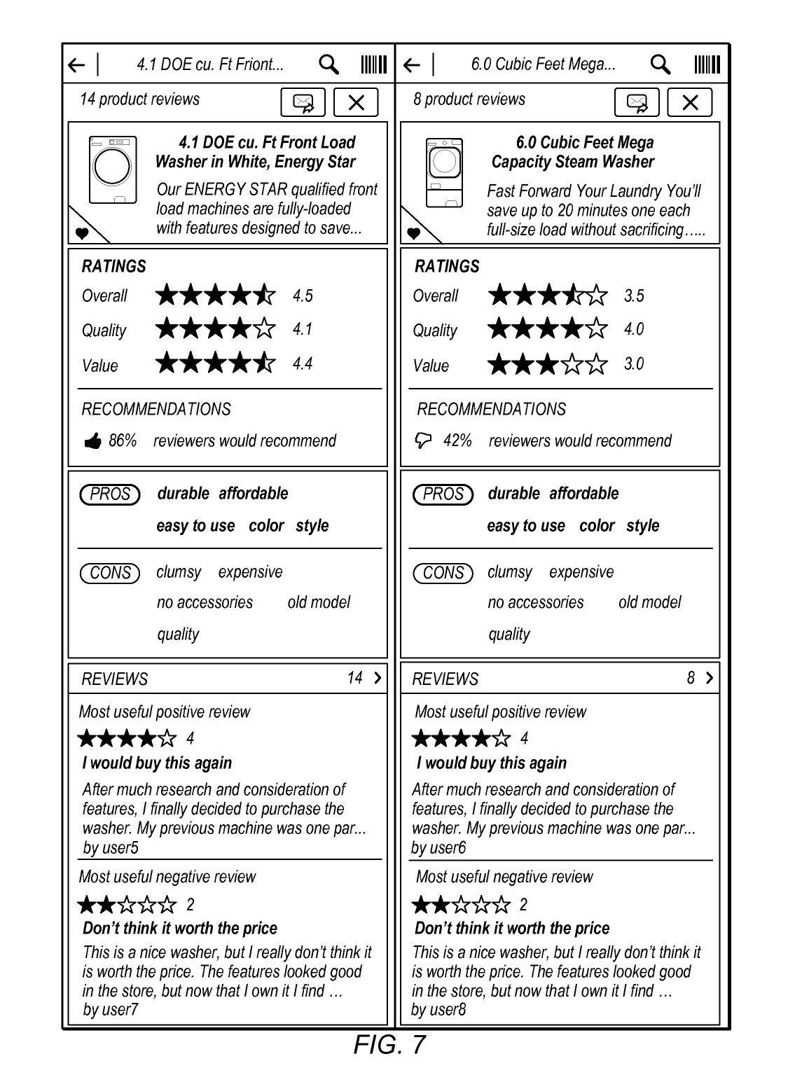

FIG. 7 shows a screenshot of a side-by-side comparison screen. According to the embodiment of FIG. 7, a user may select two or more products for comparison. Such a comparison may be based on various aspects (in some embodiments based on various pieces of UGC). For example, FIG. 7 shows three different types of star ratings (overall rating, quality rating, and value rating). Other aspects that may be compared may include percentage of reviewers who recommend the product, user-identified pros and cons of the product, number of reviews, the most useful positive review, the most useful negative review, etc.

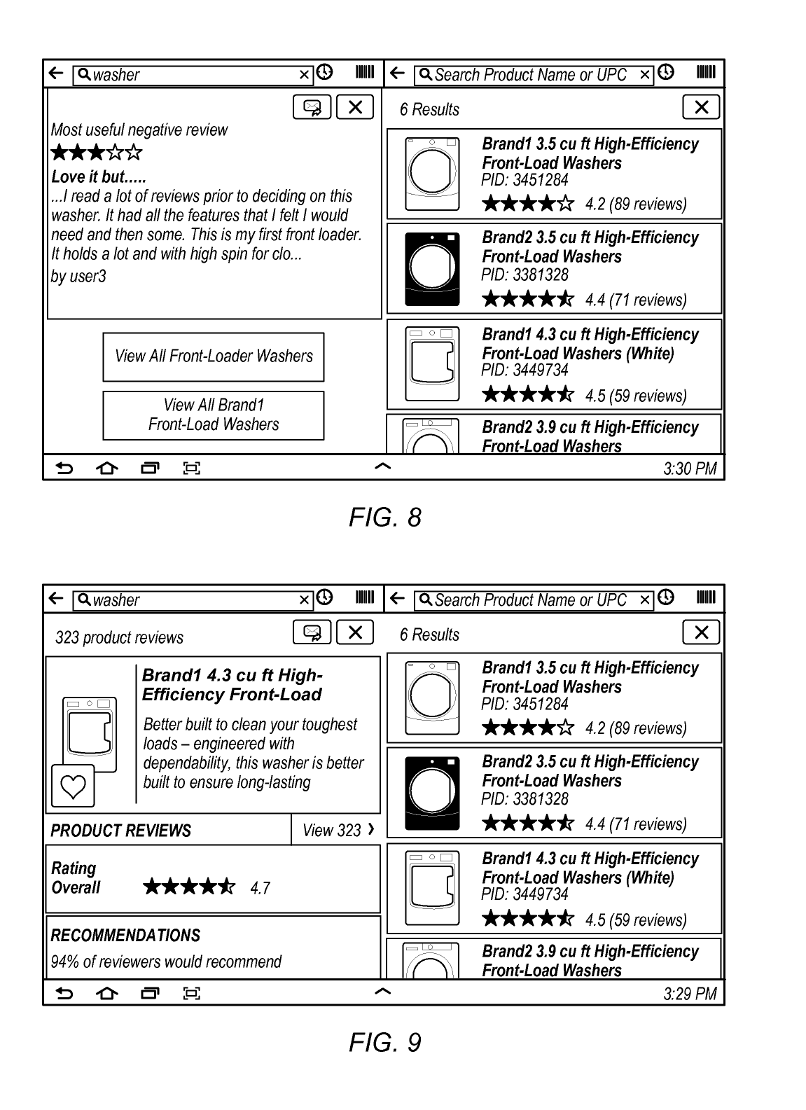

FIGS. 8 and 9 show screenshots, respectively, of two different aspects of comparing a particular product with similar products. In FIG. 8, for example, the user has selected a particular Brand1 front-load washer and is given the option of viewing either all front-load washers or all Brand1 front-load washers. The similar products may be viewed on the same screen as reviews for the particular selected product, as shown. FIG. 9 shows a related aspect, in which the similar products are shown on the same page as the product summary information for the particular product that the user is viewing. In some embodiments, candidates for comparison may be filtered and/or ordered based on various criteria, including criteria that may be selected by a provider based on current business rules. For example, a retailer may decide to present certain product models at the top of a comparison list in order to increase opportunities for sales of those certain products. In some cases, items that are currently out-of-stock may be omitted from a comparison list.

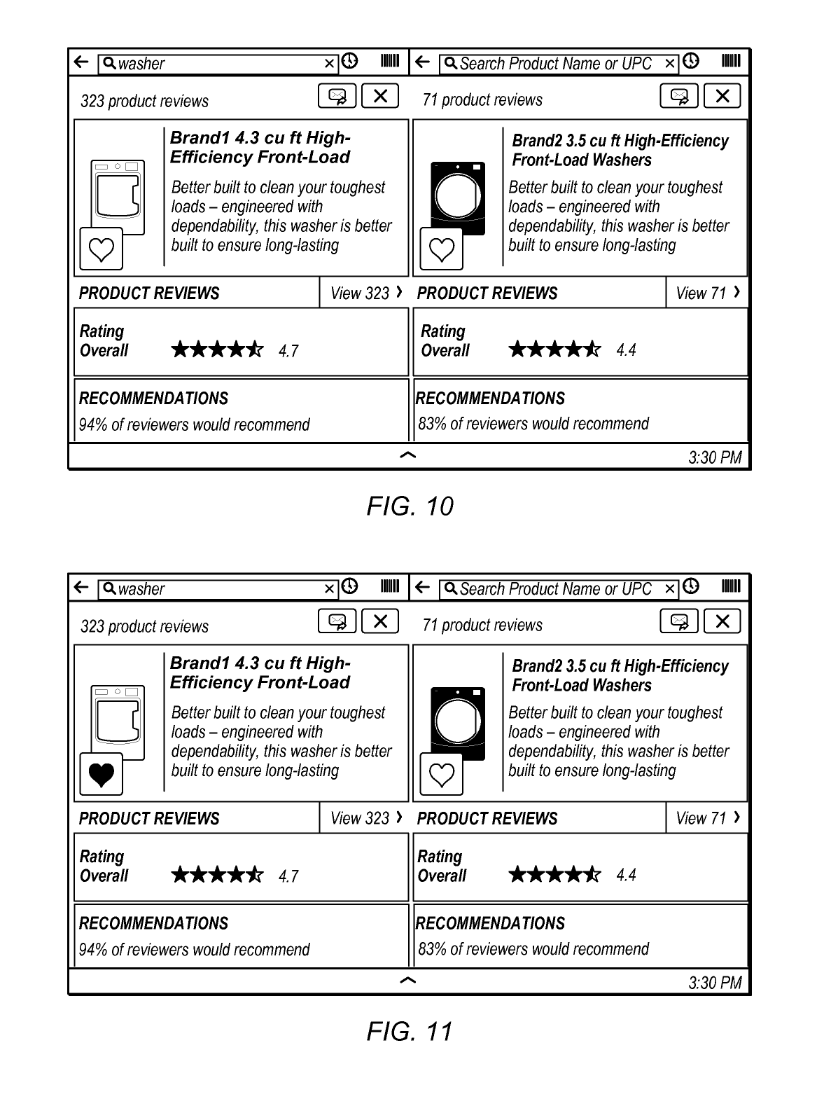

FIGS. 10 and 11 show screenshots, respectively, of two different aspects of comparing two selected products. In both of these embodiments, corresponding elements of UGC are aligned between the two products (e.g., overall star ratings are matched up for comparison). As shown in FIG. 11, a “heart” icon has been selected for the Brand1 icon indicating some preference that may be stored by the application. In some embodiments, this preference indication may have been made by the store associate to indicate that the consumer purchased the Brand1 product after comparing the Brand1 and Brand2 products. Such information may be of value to providers. For example, a retailer may use aggregations of this preference information in planning future inventory and/or sales incentives. Similarly, a brand may use this preference information as an indication that product and/or marketing scrutiny is warranted. In some other embodiments, the preference indication may be made by the consumer or by the store associate as a notation to aid the consumer during subsequent further product research.

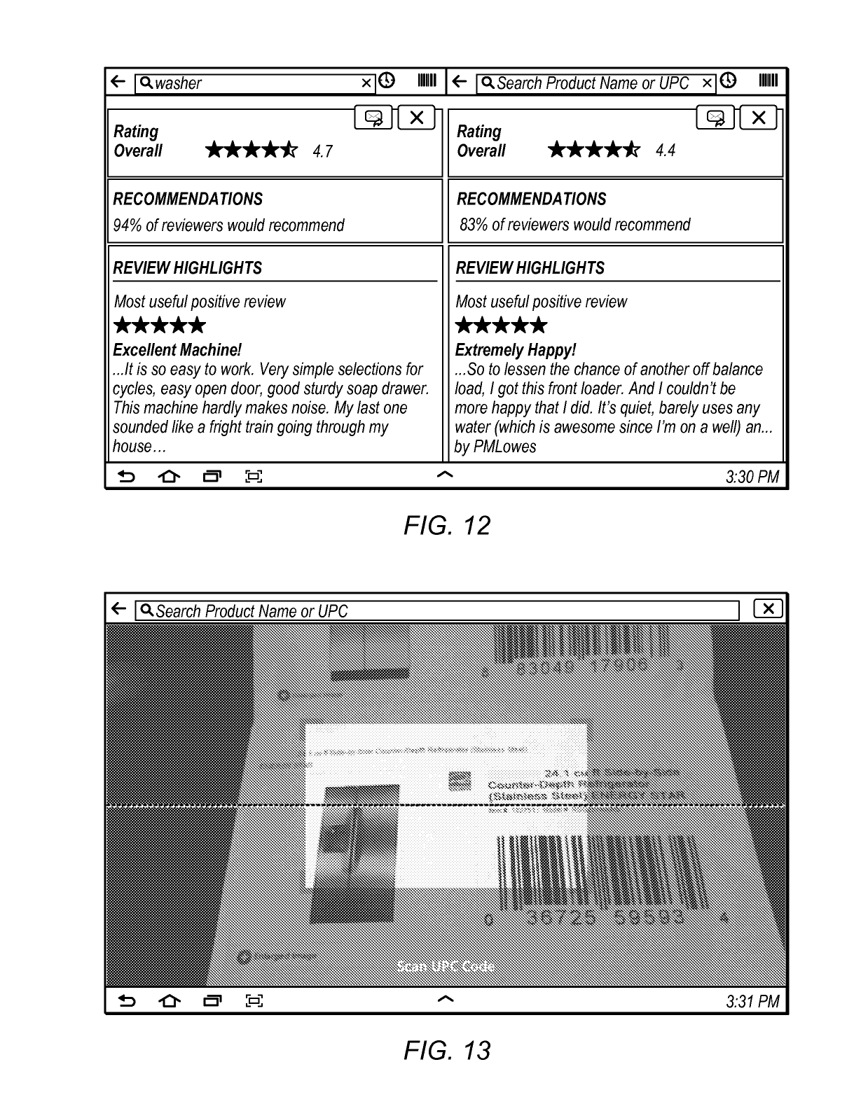

FIG. 12 shows a screenshot illustrating another aspect of the comparison shown in FIGS. 10 and 11. The information corresponding to the two products may be independently scrollable, such that, for example, the user may scroll down in the information corresponding to one product but not the other. In FIG. 12, however, the information corresponding to the two products is “locked” together, so that they scroll simultaneously. This aspect may be advantageous for simplifying the comparison, by keeping corresponding items of UGC next to each other.

FIG. 13 shows a screenshot of an aspect of an embodiment of this disclosure in which a product is selected for comparison. According to the previous discussion, products are typically selected by searching within the application. According to this aspect, however, a product may be selected by scanning a physical product in-store (e.g., via its barcode). According to this embodiment, if a consumer approaches a sales associate with a particular product and asks for a comparison to similar products, the sales associate can simply scan the product instead of performing a manual search.

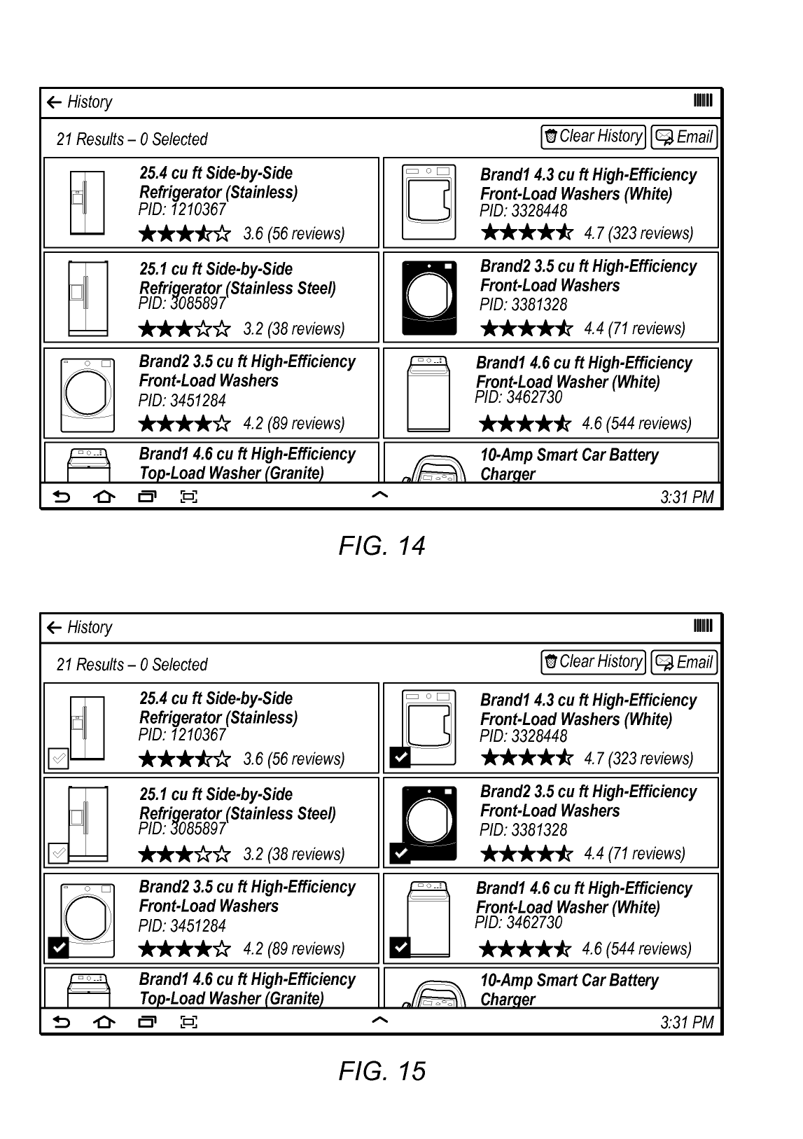

FIGS. 14 and 15 show screenshots of an aspect of this disclosure related to browsing history. FIG. 14 presents a list of all products that a consumer has viewed during a particular in-store session. A sales associate may desire to send an electronic message to the consumer with the browsing history in order to increase the chance of a completed sale, but the consumer may not always still be interested in every product in the browsing history. Accordingly, as shown in FIG. 15, a subset of the products in the browsing history may be selected with, for example, check marks. That subset may then be sent to the consumer. In other embodiments, the entire browsing history may be sent to the consumer.

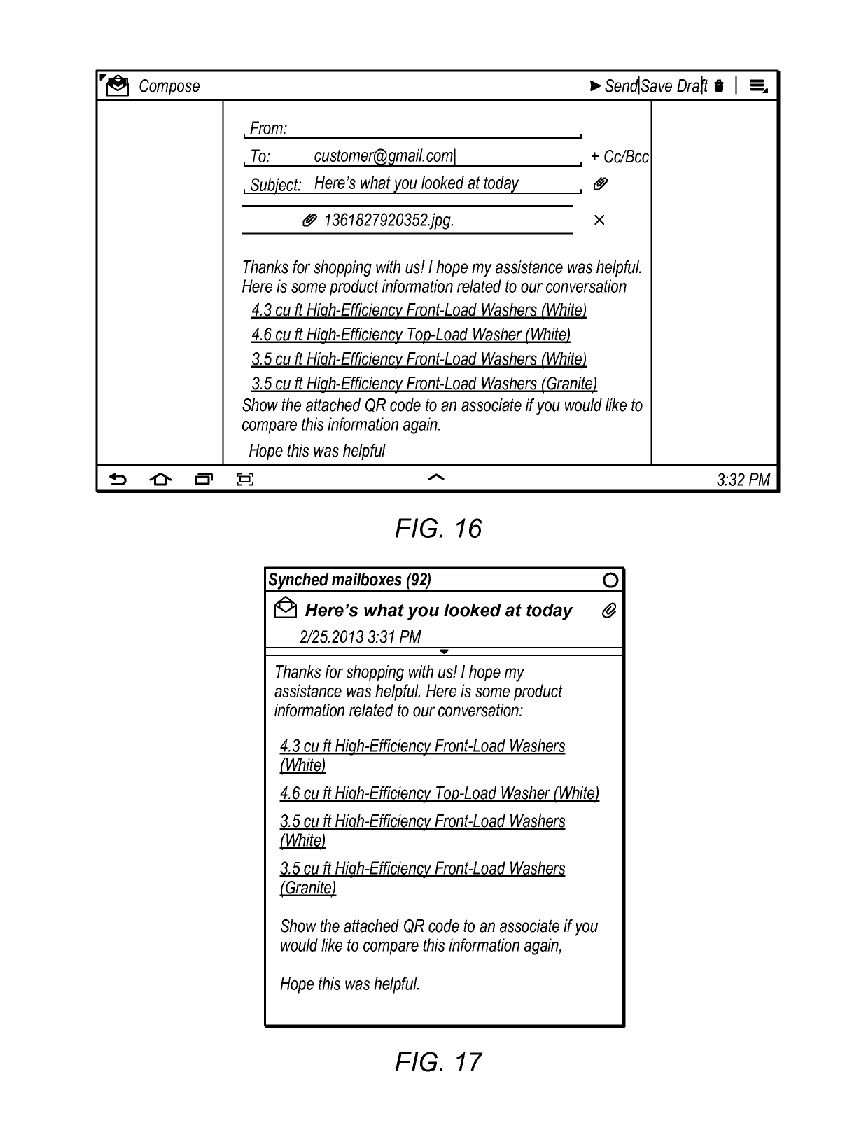

FIGS. 16 and 17 show screenshots of an aspect of this disclosure related to transmitting the browsing history to the consumer via electronic message. FIG. 16 shows an embodiment in which a sales associate can customize the message to the consumer with, e.g., a personalized message to go along with the browsing history, links, and barcode. FIG. 17 shows an example of an email as it might be received by the consumer.

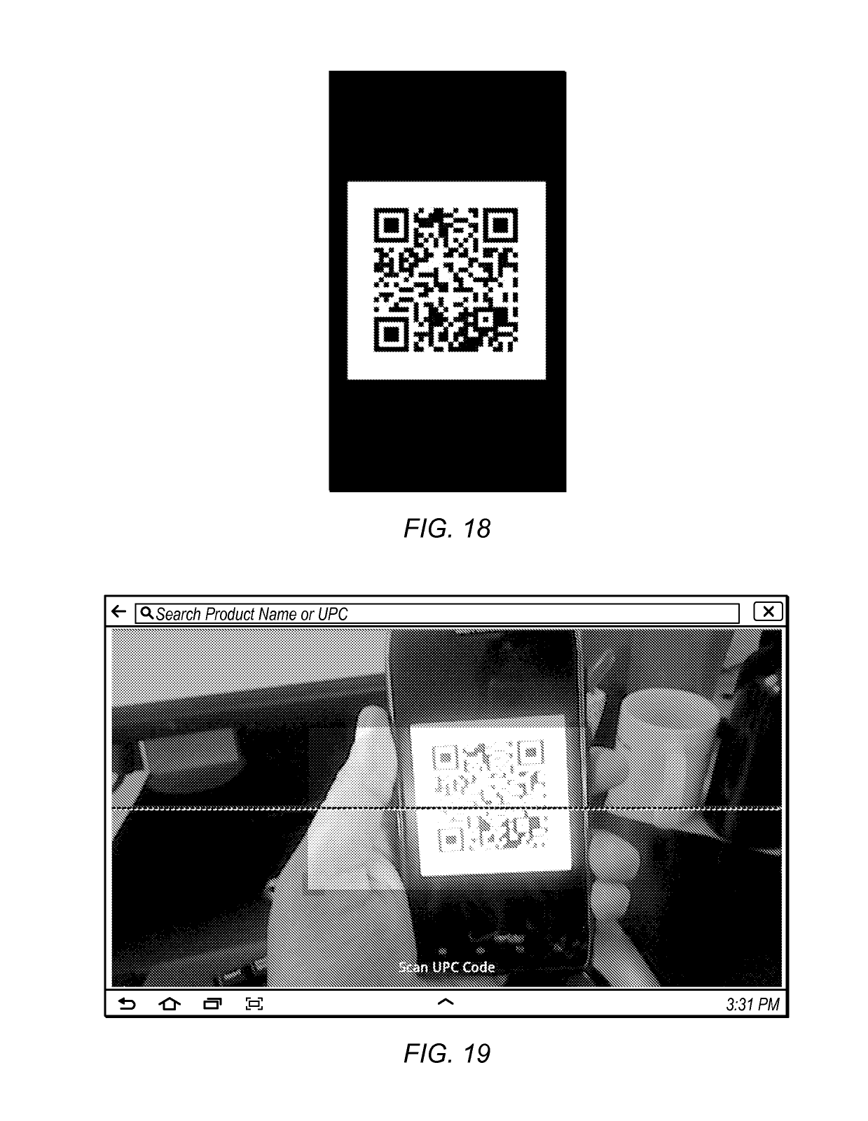

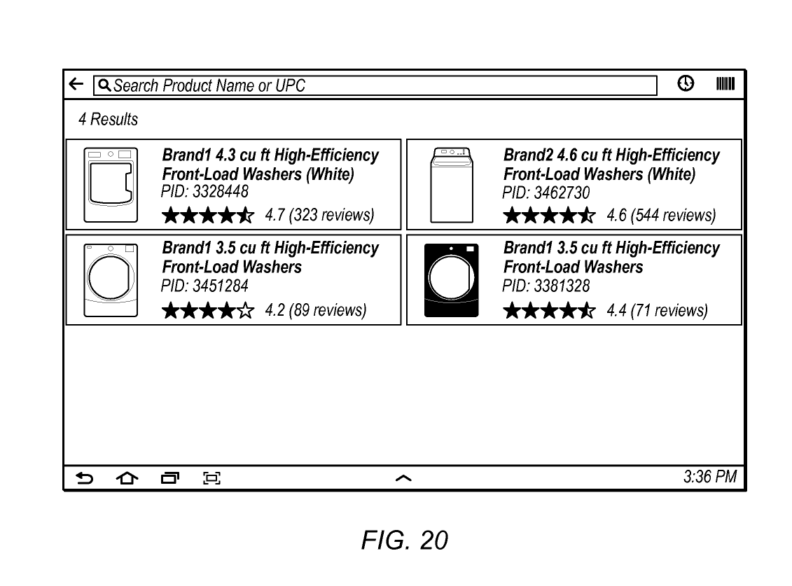

FIGS. 18-20 show screenshots of an aspect of this disclosure related to the recall of a consumer's browsing history on a subsequent visit to a store. FIG. 18 shows a screen that might be shown on the consumer's own smartphone or other device, and/or may be printed out by the consumer (e.g., from the consumer's home computer). In this embodiment, a QR code is displayed that encodes information relating to the user's previous product browsing history. FIG. 19 shows an example screenshot of what a sales associate's mobile device might display as the sales associate scans the consumer's QR code to recall the browsing history. FIG. 20 shows an example of the browsing history that might be recalled after the sales associate scans the QR code. In some embodiments, notes made by a sales associate (e.g., during a consumer's previous visit(s) to a store) may also be presented. In some embodiments, coupons may be presented based on the product browsing history.

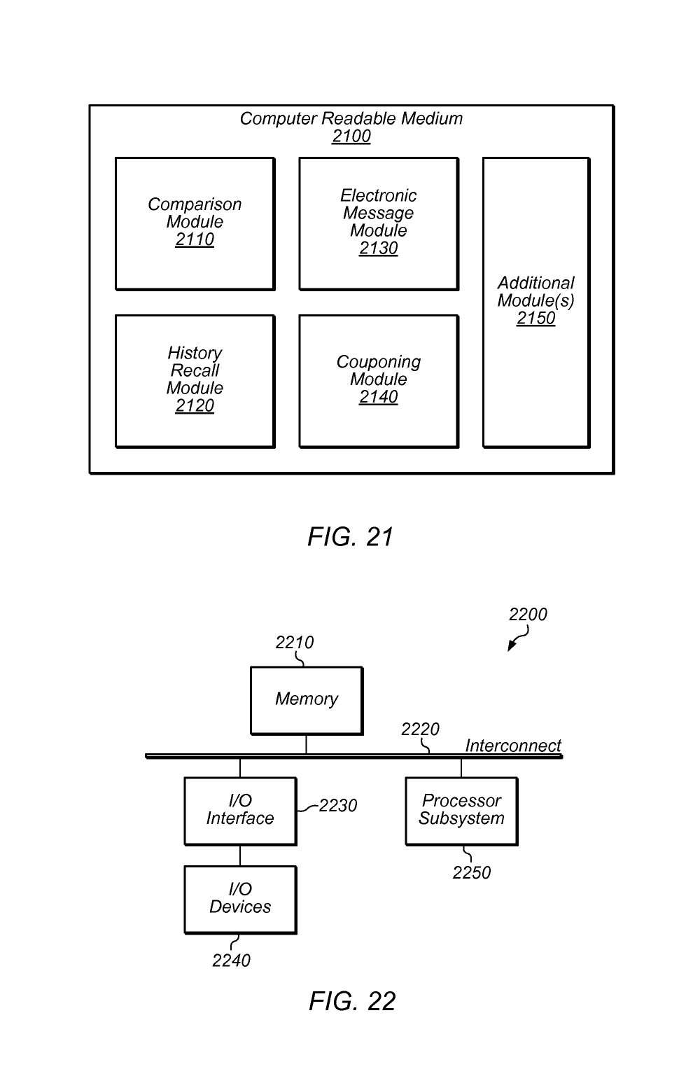

The above-described techniques and methods may be implemented as computer-readable instructions stored on any suitable computer-readable storage medium, such as medium 2100 in FIG. 21. Medium 2100 may represent a storage medium within one of computing devices 102, as well as a storage medium within entity system 110 and/or a storage medium within provider system 120. As used herein, the term computer-readable storage medium refers to a (nontransitory, tangible) medium that is readable by a computing device or computer system, and includes magnetic, optical, and solid-state storage media such as hard drives, optical disks, DVDs, volatile or nonvolatile RAM devices, holographic storage, programmable memory, etc. The term “non-transitory” as applied to computer-readable media herein is intended to exclude from claim scope only any subject matter that is deemed to be ineligible under 35 U.S.C. §101, such as transitory (intangible) media (e.g., carrier waves per se), and is not intended to exclude any subject matter otherwise considered to be statutory.

Computer-readable storage media can be used, in various embodiments, to store executable instructions and/or data. In some embodiments, particular functionality may be implemented by one or more software “modules”. A software module may include one or more executable files, web applications, and/or other files, and in some embodiments, and may make use of PHP, JAVASCIPT, HTML, Objective-C, JAVA, or any other suitable technology. In various embodiments, software functionality may be split across one or more modules and/or may be implemented using parallel computing techniques, while in other embodiments various software functionality may be combined in single modules. Software functionality may be implemented and/or stored on two or more computer systems (e.g., a server farm, or a front-end server and a back-end server and/or other computing systems and/or devices) in various embodiments.

Turning now to FIG. 21, an embodiment of computer readable storage medium 2100 is shown. In various embodiments, any or all of the modules (or a portion thereof) in medium 2100 can be present in any computer system or computing device described herein (e.g., such as provider system 120 or computing device 102). As shown, computer readable storage medium 2100 includes comparison module 2110, history recall module 2120, electronic message module 2130, and couponing module 2140. In some embodiments, one or more additional module(s) 2150 may also be present, which may be executed to cause one or more additional steps to be performed. In general, any steps, details, characteristics, or features described relative to the methods, systems, apparatuses, and/or computer-readable media of this disclosure may be suitably combined as consistent with this disclosure in various embodiments.

Turning now to FIG. 22, one embodiment of an exemplary computer system 2200 is depicted. Computer system 2200 includes a processor subsystem 2250 that is coupled to a system memory 2210 and I/O interfaces(s) 2230 via an interconnect 2220 (e.g., a system bus). I/O interface(s) 2230 are coupled to one or more I/O devices 2240. Computer system 2200 may be any of various types of devices, including, but not limited to, a server or mainframe system (for example, entity system 110 and/or provider system 120), a personal computer system, a desktop computer, a laptop or notebook computer, a handheld computer, a tablet, a workstation, a network computer, or a device such as a mobile phone, a personal data assistant (PDA), palmtop, or a tablet (for example, computing device 102). Although a single computer system 2200 is shown for convenience, the system may also be implemented as two or more computer systems operating together.

Processor subsystem 2250 may include one or more processors or processing units. In various embodiments of computer system 2200, multiple instances of the processor subsystem may be coupled to interconnect 2220. In various embodiments, processor subsystem 2250 (or each processor unit within the subsystem) may contain a cache or other form of on-board memory. In one embodiment, processor subsystem 2250 may include one or more processors.

System memory 2210 is usable by processor subsystem 2250. System memory 2210 may be implemented using different physical memory media, such as hard disk storage, floppy disk storage, removable disk storage, flash memory, random access memory (RAM-SRAM, EDO RAM, SDRAM, DDR SDRAM, RDRAM, etc.), read only memory (PROM, EEPROM, etc.), and so on. Memory in computer system 2200 is not limited to primary storage. Rather, computer system 2200 may also include other forms of storage such as cache memory in processor subsystem 2250 and secondary storage on the I/O Devices 2240 (e.g., a hard drive, storage array, etc.). In some embodiments, these other forms of storage may also store program instructions executable by processor subsystem 2250.

I/O interfaces 2230 may be any of various types of interfaces configured to couple to and communicate with other devices, according to various embodiments. In one embodiment, I/O interface 2230 is a bridge chip (e.g., Southbridge) from a front-side to one or more back-side buses. I/O interfaces 2230 may be coupled to one or more I/O devices 2240 via one or more corresponding buses or other interfaces. Examples of I/O devices 2240 include storage devices (hard drive, optical drive, removable flash drive, storage array, SAN, or their associated controller), network interface devices (e.g., to a local or wide-area network), or other devices (e.g., graphics, user interface devices, etc.).

In one embodiment, computer system 2200 is coupled to a network via a network interface device. The network interface device may be a wireless interface in various embodiments. In other embodiments, computer system 2200 is part of a cloud-based computing service. In general, the present disclosure is not limited to any particular type of computer architecture.

Various features have been disclosed. For example, a non-exhaustive list of some features according to this disclosure includes the following:
Side-by-side comparison of product information (e.g., product specifications and UGC relating products)
Capturing browsing history associated with a consumer
Transmitting browsing history to a consumer
Crediting a sales associate via the transmitted browsing history
Dynamic couponing
Providing a barcode to a consumer for subsequent visits
Messaging between associates
Product suggestions

This disclosure contemplates software that incorporates any and all combinations of the disclosed features, regardless of whether a particular combination is discussed or claimed explicitly.

### Embodiments

A non-limiting list of embodiments of the present disclosure include the following:
1. A method, comprising:

a sales associate, in a physical store of an entity, using a software application running on a mobile device to assist a consumer in shopping for products or services offered via the physical store;

wherein the software application is executable to retrieve user-generated content (UGC) items regarding the products or services, and to display at least a portion of the retrieved UGC items on the mobile device;

wherein the software application is executable to cause storage of a browsing history indicative of one or more products and services for which the consumer viewed information via the software application; and

wherein the software application is executable to initiate an electronic message to the consumer that is usable to view the browsing history.

2. The method of embodiment 1, wherein the software application is executable to retrieve UGC items only for products or services offered by the entity.
3. The method of embodiment 1, wherein the electronic message includes the browsing history.
4. The method of embodiment 1, wherein the electronic message includes a link to the browsing history.
5. The method of embodiment 1, wherein the electronic message includes one or more links selectable by the consumer to effectuate a purchase of one or more of the products or services indicated in the browsing history.
6. The method of embodiment 5, wherein selection of one of the one or more links in the electronic message is usable to attribute the purchase to the physical store.
7. The method of embodiment 5, wherein selection of one of the one or more links in the electronic message is usable to attribute the purchase to the sales associate.
8. The method of embodiment 1, wherein the browsing history includes notes entered by the sales associate using the software application while the consumer was in the physical store.
9. The method of embodiment 1, wherein the electronic message includes a barcode, and wherein the method further comprises:

an instance of the software application reading the barcode, wherein the instance of the software application is running on a different mobile device of the entity; and

the instance of the software application retrieving, based on the barcode, the browsing history.

10. The method of embodiment 1, wherein the browsing history indicates products or services that the consumer compared using the software application.
11. The method of embodiment 1, wherein the software application is executable to display a side-by-side comparison of two products or services on the mobile device.
12. The method of embodiment 11, wherein the software application is executable, in response to the display of the side-by-side comparison, to issue an electronic coupon to the consumer for one of the two products or services displayed on the mobile device.
13. The method of embodiment 1, wherein the software application is executable, in response to displaying information relating to a first product or service to the consumer, to suggest one or more other products or services to compare to the first product or service.
14. The method of embodiment 1, wherein the software application is executable to communicate notes entered by the sales associate regarding the products or services offered via the physical store to a central server, and wherein the software application is executable to retrieve, from the central server, notes entered by other sales associates regarding the products or services offered via the physical store or other physical stores of the entity.
15. A method, comprising:

retrieving user-generated content (UGC) items regarding products or services offered for purchase by the entity via the physical store;

displaying at least a portion of the retrieved UGC items to a consumer;

causing storage of a browsing history indicative of one or more products and services for which the consumer viewed information via the mobile device at the physical store; and

initiating generation of an electronic message to the consumer that is usable to view the browsing history and to effectuate an online purchase of one or more products or services included in the browsing history.

16. The method of embodiment 15, wherein the electronic message facilitates attributing the online purchase to the physical store.
17. The method of embodiment 15, wherein said displaying at least a portion of the retrieved UGC includes displaying a side-by-side comparison of two products or services, and, in response to the display of the side-by-side comparison, issuing an electronic coupon to the consumer for one of the two products or services.
18. A method, comprising:

storing, via a software application executing on a mobile device, a browsing record of products or services viewed by a consumer using the software application at a physical store of an entity;

initiating sending an electronic message to the consumer, wherein the electronic message is usable to view the browsing record; and

receiving from the consumer, at a computer system associated with the entity, a request to purchase one or more of the products or services indicated in the browsing record, wherein the request is received via a link included in the browsing record; and

storing an indication that the request to purchase is attributable to the physical store.

19. The method of embodiment 18, wherein the indication that the request is attributable to the physical store is an indication that the request is attributable to a particular sales associate at the physical store.
20. The method of embodiment 18, wherein the browsing record includes notes regarding the consumer's preferences, wherein the notes were entered by a sales associate of the entity.
21. A method, comprising:

receiving, at a computer system, an indication that a consumer is using a software application to compare information relating to at least two products or services;

determining, at the computer system, to issue a coupon for a particular one of the at least two products or services, wherein the determining is based on the indication; and

causing the coupon to be displayed to the consumer via the software application.

22. The method of embodiment 21, wherein the software application is running on a mobile device in communication with the computer system.
23. The method of embodiment 22, wherein causing the coupon to be displayed includes sending the coupon to the mobile device.
24. The method of embodiment 21, wherein the software application is running on the computer system.
25. The method of embodiment 21, wherein the coupon offers a price discount for the particular one of the at least two products or services.
26. The method of embodiment 21, wherein the at least two products or services are offered by an entity, and wherein the software application is executable to retrieve information only for products or services offered by the entity.
27. The method of embodiment 21, wherein the software application is a browser application.
28. The method of embodiment 21, wherein the determining is based on a rule established by a provider of the particular one of the at least two products or services.
29. A method, comprising:

determining, at a computer system, that a consumer is using a software application to compare information relating to at least two products or services; and

in response to the determining, the computer system causing a coupon for a particular one of the at least two products or services to be displayed to the consumer via the software application.

30. The method of embodiment 29, wherein the computer system is a mobile device on which the software application is executing.
31. The method of embodiment 29, wherein the computer system is in communication with a mobile device on which the software application is executing.
32. The method of embodiment 31, wherein causing the coupon to be displayed to the consumer includes:

determining to issue the coupon; and

sending the coupon to the mobile device.

33. The method of embodiment 32, wherein determining to issue the coupon is performed in response to determining that the particular one of the at least two products or services is being compared to one of a specific set of other products or services.
34. The method of embodiment 32, wherein the particular one of the at least two products or services is offered by a first provider, and wherein determining to issue the coupon is performed in response to determining that the particular one of the at least two products or services is being compared to a product or service offered by a second provider.
35. A method, comprising:

a software application displaying, on a mobile device, side-by-side comparisons of at least two products or services; and

the software application displaying, on the mobile device, a coupon for a particular one of the at least two products or services, wherein the coupon is issued in response to the displayed side-by-side comparison.

36. The method of embodiment 35, further comprising:

the software application communicating, to a remote computer system, an indication that the at least two products or services are being compared; and

the software application receiving the coupon from the remote computer system.

37. The method of embodiment 35, wherein the coupon is issued based on a rule established by a provider of the particular one of the at least two products or services.
38. A method, comprising:

a sales associate in a physical store of an entity using a software application running on a mobile device to assist a consumer in shopping for products or services offered via the physical store;

wherein the software application is executable to display side-by-side comparisons of at least two products or services and to display a dynamically issued coupon for a particular one of the at least two products or services.

39. The method of embodiment 38, wherein the coupon is redeemable at the physical store of the entity.
40. The method of embodiment 38, wherein the coupon is redeemable by the consumer for a future price discount on an item.
41. A method comprising:

receiving, at a computer system, an indication that a consumer is using a software application to compare information relating to products or services offered by at least two different providers;

determining, at the computer system, to issue a coupon for a particular product or service offered by one of the at least two providers, wherein the determining is based on the indication; and

causing the coupon to be displayed to the consumer via the software application.

42. A method, comprising:

a sales associate, in a physical store of an entity, using a software application running on a mobile device to assist a consumer in shopping for products or services offered via the physical store;

wherein the software application is executable to cause storage of a browsing history indicative of one or more products and services for which the consumer viewed information via the software application; and

wherein the software application is further executable to supply a machine-readable image that is readable by a given instance of the software application, wherein the machine-readable image is usable to subsequently access the browsing history.

43. The method of embodiment 42, further comprising:

a different sales associate using an instance of the software application to access the browsing history during a subsequent time that the consumer is present at the physical store.

44. The method of embodiment 42, further comprising:

a different sales associate using an instance of the software application to access the browsing history during a subsequent time that the consumer is present at a different physical store of the entity.

45. The method of embodiment 42, wherein the machine-readable image is usable, by a different sales associate, to access the browsing history during a subsequent time that the consumer is present at the physical store.
46. The method of embodiment 42, wherein the machine-readable image is usable, by a different sales associate at a different physical store of the entity, to access the browsing history.
47. The method of embodiment 42, wherein the machine-readable image is a two-dimensional barcode.
48. A method, comprising:

a sales associate, in a physical store of an entity, using a software application running on a mobile device to display, to a consumer, information relating to products or services offered via the physical store;

the sales associate inputting content into the software application, wherein the content relates to a particular one of the one or more of the products or services displayed to the consumer; and

storing the content on a central computer system associated with the entity such that the content is accessible to other sales associates using other instances of the software application to access information about the particular product or service.

49. The method of embodiment 48, wherein at least one of the other sales associates is at a different physical store of the entity.
50. The method of embodiment 48, wherein the content is further accessible by a provider of the products or services.
51. A method, comprising:

a sales associate, in a physical store of an entity, using a software application running on a mobile device to display, to a consumer, information relating to products or services offered via the physical store, wherein the displayed information includes user-generated content (UGC) items relating to the products or services;

the sales associate initiating, via the software application, the sending of a message relating to a particular one of the one or more of the products or services displayed to the consumer, wherein the message is communicated to mobile devices of other sales associates of the entity using other instances of the software application; and

the sales associate receiving, via the software application, a response to the message from one of the other sales associates.

52. A method, comprising:

in a physical store of an entity, a software application running on a mobile device displaying, to a consumer, information relating to products or services offered via the physical store, wherein the information includes user-generated content (UGC) items;

the software application receiving a selection of a particular one of the one or more of the products or services displayed to the consumer; and

in response to the selection of the particular product or service, the software application displaying a plurality of suggested other products or services;

the software application receiving a selection of the one of the plurality of suggested other products or services;

in response to the selection of the other product or service, the software application displaying comparison information about the particular product or service and the other product or service side-by-side on the mobile device.

53. The method of embodiment 52, wherein the plurality of suggested other products or services are determined by a remote computer system.
54. The method of embodiment 52, wherein the plurality of suggested other products or services are determined by the mobile device based on one or more rules provided by a remote computer system.
55. The method of embodiment 52, further comprising storing the UGC items on a central computer system associated with the entity such that the UGC items are accessible to other sales associates using other instances of the software application to access information about the particular product or service.
56. A computer system comprising:

at least one processor; and

a memory having instructions coded thereon which, when executed by the computer system, using the at least one processor, cause the computer system to perform the method of any of the preceding embodiments.

57. A non-transitory computer-readable storage medium having program instructions stored thereon that are executable by a computing device to cause the computing device to perform the method of any of embodiments 1-55.

Although specific embodiments have been described herein, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Additionally, section or heading titles provided above in the detailed description should not be construed as limiting the disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
a sales associate, in a physical store of an entity, using a software application running on a mobile device to assist a consumer in shopping for products or services offered via the physical store;
wherein the software application is executable to retrieve user-generated content (UGC) items regarding the products or services, and to display at least a portion of the retrieved UGC items on the mobile device;
wherein the software application is executable to cause storage of a browsing history indicative of one or more products and services for which the consumer viewed information via the software application; and
wherein the software application is executable to initiate an electronic message to the consumer that is usable to view the browsing history.

2. The method of claim 1, wherein the software application is executable to retrieve UGC items only for products or services offered by the entity.

3. The method of claim 1, wherein the electronic message includes the browsing history.

4. The method of claim 1, wherein the electronic message includes a link to the browsing history.

5. The method of claim 1, wherein the electronic message includes one or more links selectable by the consumer to effectuate a purchase of one or more of the products or services indicated in the browsing history.

6. The method of claim 5, wherein selection of one of the one or more links in the electronic message is usable to attribute the purchase to the physical store.

7. The method of claim 5, wherein selection of one of the one or more links in the electronic message is usable to attribute the purchase to the sales associate.

8. The method of claim 1, wherein the browsing history includes notes entered by the sales associate using the software application while the consumer was in the physical store.

9. The method of claim 1, wherein the electronic message includes a barcode, and wherein the method further comprises:
an instance of the software application reading the barcode, wherein the instance of the software application is running on a different mobile device of the entity; and
the instance of the software application retrieving, based on the barcode, the browsing history.

10. The method of claim 1, wherein the browsing history indicates products or services that the consumer compared using the software application.

11. The method of claim 1, wherein the software application is executable to display a side-by-side comparison of two products or services on the mobile device.

12. The method of claim 11, wherein the software application is executable, in response to the display of the side-by-side comparison, to issue an electronic coupon to the consumer for one of the two products or services displayed on the mobile device.

13. The method of claim 1, wherein the software application is executable, in response to displaying information relating to a first product or service to the consumer, to suggest one or more other products or services to compare to the first product or service.

14. The method of claim 1, wherein the software application is executable to communicate notes entered by the sales associate regarding the products or services offered via the physical store to a central server, and wherein the software application is executable to retrieve, from the central server, notes entered by other sales associates regarding the products or services offered via the physical store or other physical stores of the entity.

15. A computer-readable medium having instructions coded thereon which, when executed by a computing device, cause the computing device to carry out operations comprising:
retrieving user-generated content (UGC) items regarding products or services offered for purchase by the entity via the physical store;
displaying at least a portion of the retrieved UGC items to a consumer;
causing storage of a browsing history indicative of one or more products and services for which the consumer viewed information via the mobile device at the physical store; and
initiating generation of an electronic message to the consumer that is usable to view the browsing history and to effectuate an online purchase of one or more products or services included in the browsing history.

16. The computer-readable medium of claim 15, wherein the electronic message facilitates attributing the online purchase to the physical store.

17. The computer-readable medium of claim 15, wherein said displaying at least a portion of the retrieved UGC includes displaying a side-by-side comparison of two products or services, and, in response to the display of the side-by-side comparison, issuing an electronic coupon to the consumer for one of the two products or services.

18. A mobile device, comprising:
at least one processor; and
a storage medium having instructions coded thereon which, when executed by the mobile device, cause the mobile device to carry out operations comprising:
storing, via a software application executing on the mobile device, a browsing record of products or services viewed by a consumer using the software application at a physical store of an entity;
initiating sending an electronic message to the consumer, wherein the electronic message is usable to view the browsing record; and
receiving from the consumer, at a computer system associated with the entity, a request to purchase one or more of the products or services indicated in the browsing record, wherein the request is received via a link included in the browsing record; and
storing an indication that the request to purchase is attributable to the physical store.

19. The mobile device of claim 18, wherein the indication that the request is attributable to the physical store is an indication that the request is attributable to a particular sales associate at the physical store.

20. The mobile device of claim 18, wherein the browsing record includes notes regarding the consumer's preferences, wherein the notes were entered by a sales associate of the entity.
